(19) United States
(12) Patent Application Publication
(10) Pub. No.: US 2014/0236475 A1
(43) Pub. Date: Aug. 21, 2014

(54) METHODS AND SYSTEMS FOR NAVIGATION IN INDOOR ENVIRONMENTS

(71) Applicant: TEXAS INSTRUMENTS INCORPORATED, Dallas, TX (US)

(72) Inventors: Narasimhan Venkatraman, Plano, TX (US); Sireesha Vemparala, Irving, TX (US)

(73) Assignee: TEXAS INSTRUMENTS INCORPORATED, Dallas, TX (US)

(21) Appl. No.: 13/770,016

(22) Filed: Feb. 19, 2013

(51) Int. Cl. G01C 21/00

(52) U.S. Cl. CPC G01C 21/00
USPC 701/420

(57) ABSTRACT

Several methods and systems for navigation in an indoor environment are disclosed. In an embodiment, a method includes receiving coded data corresponding to a plurality of destinations in an indoor environment. The coded data is received on a device associated with a user from at least one data source provided in the indoor environment. The method further includes determining one or more navigation paths corresponding to at least one destination from among the plurality of destinations based on the coded data. The one or more navigation paths facilitate user navigation in the indoor environment.

### TECHNICAL FIELD

The present disclosure generally relates to the field of navigation.

### BACKGROUND

Pursuant to an exemplary scenario, navigation aids such as maps are utilized to obtain route directions so as to enable various individuals to reach specific destinations. With the rapid advancement in navigation technology and widespread proliferation of multimedia devices, navigation may be facilitated by electronic tools, which might utilize a combination of electronic maps of geographical areas of interest and satellite (and/or cellular) signals in order to track a user location. Pursuant to an exemplary scenario, signals from one or more global navigation satellite systems (GNSS) may be utilized to compute user location co-ordinates on the map, which may then be used to dynamically provide directions for routes that are to be followed in order to reach specific destinations. Though such signals may facilitate navigation in outdoor environments with reasonable accuracy, they may be rendered ineffective in indoor environments as a result of a severe attenuation caused by obstacles, such as the walls of the buildings. Moreover, electronic maps of various indoor environments, such as malls, parking areas, and building complexes may not be available, thereby rendering navigation in such environments relatively difficult.

### SUMMARY

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter.

Various systems, methods, and computer-readable mediums for facilitating navigation in indoor environments are disclosed. In an embodiment, a method includes receiving coded data corresponding to a plurality of destinations in an indoor environment. The coded data is received on a device associated with a user from at least one data source provided in the indoor environment. The method further includes determining one or more navigation paths corresponding to at least one destination from among the plurality of destinations based on the coded data. The one or more navigation paths facilitate user navigation in the indoor environment.

In an embodiment, an initial location of the user is determined based on a location of a first data source from among the at least one data source upon receiving coded data from the first data source. One or more destinations from among the plurality of destinations are displayed on the device based on the initial location of the user and the coded data received from the first data source. In an embodiment, a user interface (UI) based view is generated in order to display the one or more destinations to the user. In an embodiment, the UI based view is generated based on augmented reality (AR). In an embodiment, the UI based view is generated by overlaying milestone information corresponding to the one or more destinations over one of a view captured by an image view-finder associated with the device and a pre-loaded map associated with the device. In an embodiment, a selection of the at least one destination from among the one or more destinations is received from the user prior to determining the one or more navigation paths.

In an embodiment, a current location of the user is dynamically tracked so as to guide the user while traversing the one or more navigation paths, where the current location of the user is dynamically tracked based on the initial location. In an embodiment, the current location of the user is dynamically tracked using at least one of an accelerometer, a gyroscope and one or more motion sensors configured for motion estimation and depth estimation.

In an embodiment, a linked list of navigation paths is created by augmenting the one or more navigation paths with navigation paths determined based on coded data received from one or more subsequent data sources provided in the indoor environment. In an embodiment, a navigation map for the indoor environment is dynamically generated based on the linked list of navigation paths. In an embodiment, the linked list of navigation paths is configured to enable a determination of a current location of the user based on dead reckoning.

In an embodiment, the coded data corresponding to a destination from among the plurality of destinations comprises at least one of milestone information, direction information and distance information with reference to a location of the user in the indoor environment. In an embodiment, a data source from among the at least one data source is one of a quick response (QR) tag, a near field communication (NFC) based apparatus, a Bluetooth® based device, and a Wi-Fi based device. In an embodiment, coded data received from a data source from among the at least one data source provided in the indoor environment comprises at least one of milestone information, direction information and distance information corresponding to another data source provided in the indoor environment.

Additionally, in an embodiment, a system configured to facilitate navigation in indoor environments is disclosed. The system includes a data acquisition module, a processing module and a display module. In an embodiment, the data acquisition module is configured to receive coded data corresponding to a plurality of destinations in an indoor environment. The coded data is received from at least one data source provided in the indoor environment. The processing module is communicatively associated with the data acquisition module and configured to determine one or more navigation paths corresponding to at least one destination from among the plurality of destinations based on the coded data. The display module is communicatively associated with the data acquisition module and the processing module and is configured to display the determined one or more navigation paths. The one or more navigation paths facilitate user navigation in the indoor environment.

Moreover, in an embodiment, a non-transitory computer-readable medium is provided. The non-transitory computer-readable medium is configured to store a set of instructions that when executed cause a computer to perform a method of facilitating navigation in indoor environments. In an embodiment, the method includes receiving coded data corresponding to a plurality of destinations in an indoor environment. The coded data is received by a device associated with a user from at least one data source provided in the indoor environment. The method further includes determining one or more navigation paths corresponding to at least one destination from among the plurality of destinations based on the coded data. The one or more navigation paths facilitate user navigation in the indoor environment.

Other aspects and exemplary embodiments are provided in the drawings and the detailed description that follows.

### BRIEF DESCRIPTION OF THE FIGURES

FIG. 1 depicts an exemplary indoor environment in which various embodiments of the present technology may be practiced;

FIG. 2 is a block diagram of an exemplary system configured to facilitate navigation in indoor environments in accordance with an embodiment;

FIG. 3 illustrates an exemplary data source in the form of a quick response (QR) tag in accordance with an embodiment;

FIG. 4 depicts an exemplary provision of the QR tag of FIG. 3 in an indoor environment in accordance with an embodiment;

FIG. 5 depicts an exemplary user interface (UI) based view generated in order to display a plurality of destinations to a user in accordance with an embodiment;

FIG. 6 depicts an exemplary schematic of a linked list in accordance with an embodiment;

FIG. 7 is a flow diagram of a first method of facilitating navigation in an indoor environment in accordance with an embodiment; and

FIG. 8 is a flow diagram of a second method of facilitating navigation in an indoor environment in accordance with an embodiment.

The drawings referred to in this description are not to be understood as being drawn to scale except if specifically noted, and such drawings are only exemplary in nature.

### DETAILED DESCRIPTION

Pursuant to an exemplary scenario, signals from one or more global navigation satellite systems (GNSS) may be utilized to compute user location co-ordinates on a map, which may then be used to dynamically provide directions for routes to be followed in order to reach specific destinations. In accordance with an exemplary scenario, global navigation satellite systems (GNSS) may be broadly defined to include global positioning system (GPS), Galileo, GLONASS, Beidou, Indian Regional Navigational Satellite System (IRNSS), Quasi-Zenith Satellite System (QZSS) and other positioning technologies using signals from satellites, with or without augmentation from terrestrial sources. Information from GNSS may be used to compute a user's position information (e.g., a location, a speed, a direction of travel, etc.). However, such signals are rendered ineffective in indoor environments as a result of severe attenuation caused by obstacles, such as walls of the buildings. Moreover, electronic maps of various indoor environments, such as malls, parking areas, and building complexes are not available, thereby causing navigation in such environments to be difficult. Various embodiments of the present technology, however, provide methods and systems for facilitating indoor navigation that are capable of overcoming these and other obstacles and providing additional benefits.

The following description and accompanying figures demonstrate that the present technology may be practiced, or otherwise implemented, in a variety of different embodiments. It should be noted, however, that the scope of the present technology is not limited to any or all of the embodiments disclosed herein. Indeed, one or more of the devices, features, operations, processes, characteristics, or other qualities of a disclosed embodiment may be removed, replaced, supplemented, or changed.

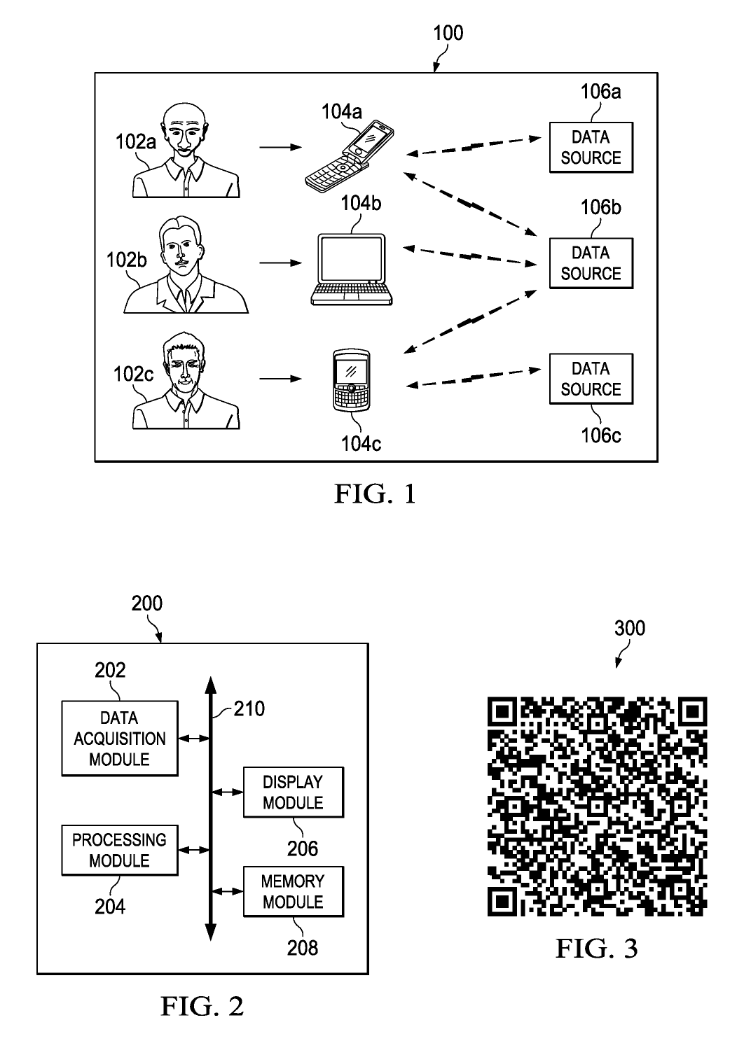

FIG. 1 depicts an exemplary indoor environment 100 in which various embodiments of the present technology may be practiced. As used hereinafter, the term ‘indoor environment’ may refer to covered spaces and/or areas within building structures, such as, for example, office spaces or areas within shopping malls, parking lots, hospitals and the like. The indoor environment 100 includes a plurality of users, such as a user 102a, a user 102b and a user 102c. It is noted that three users are depicted in FIG. 1 for exemplary purposes, and that the indoor environment 100 may include a greater or lesser number of users. The users, such as users 102a-102c are hereinafter collectively referred to as the plurality of users. Each user from among the plurality of users is depicted to be associated with a device. For example, the user 102a is associated with a device 104a, the user 102b is associated with a device 104b, and the user 102c is associated with a device 104c. The devices, such as devices 104a-104c, are hereinafter collectively referred to as plurality of devices. The indoor environment 100 is further depicted to include a plurality of data sources, such as a data source 106a, a data source 106b and a data source 106c. It is noted that three data sources are depicted in FIG. 1 for exemplary purposes, and that the indoor environment 100 may include a greater or lesser number of data sources. The data sources, such as the data sources 106a-106c are collectively referred to as the plurality of data sources.

In an embodiment, each device from among the plurality of devices is configured to communicate with one or more data sources from among the plurality of data sources. In an embodiment, such a communication may be rendered wirelessly. In FIG. 1, the device 104a is depicted to communicate with data sources 106a and 106b, the device 104b is depicted to communicate with data source 106b, and the device 104c is depicted to communicate with data sources 106b and 106c. It is noted that the various communications (shown as dotted arrows) between the devices 104a-104c and the data sources 106a-106c are depicted for exemplary purposes and that a device from among the plurality of devices may be configured to communicate with any of the plurality of data sources.

In an embodiment, the plurality of data sources may be centrally located within the indoor environment 100. In an embodiment, the plurality of data sources may be geographically dispersed within the indoor environment 100. For example, a data source from among the plurality of data sources may be provided at the entrance of a commercial building or a shopping mall with other data sources provided at various locations, such as, for example, outside offices or shops, next to vending machines, near elevators, and the like.

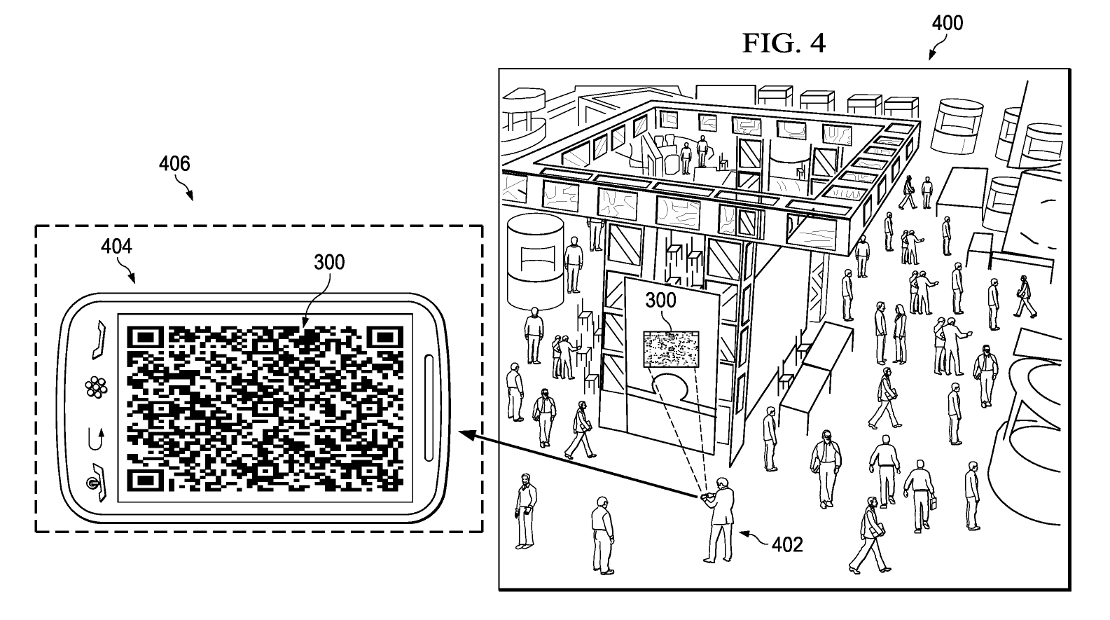

In an embodiment, a data source from among the plurality of data sources is at least one of a quick response (QR) tag, a near field communication (NFC) based apparatus, a Bluetooth® based device (for example, Bluteooth® low energy (BLE) based device) and a Wi-Fi based device. In an embodiment, each data source from among the plurality of data sources includes data in coded form. In an embodiment, the coded data may be in the form of a QR code, a bar code, a near field communication (NFC) signal, a Bluetooth® signal (for example, a Bluetooth® low energy signal), a Wi-Fi signal, and the like. In an embodiment, the coded data corresponds to a plurality of destinations in the indoor environment 100. For example, if the indoor environment 100 corresponds to an area associated with a commercial building, then the plurality of destinations may correspond to one or more offices within the building. Similarly, if the indoor environment 100 corresponds to an area associated with a shopping mall, then the plurality of destinations may correspond to shops, restaurants, restrooms, café joints, and the like. In an embodiment, the coded data corresponding to a destination comprises at least one of milestone information, direction information and distance information with reference to a location of the user in the indoor environment 100. The coded data is further explained herein with reference to FIGS. 3 and 4.

In an embodiment, a device from among the plurality of devices may be configured to communicate with a data source of the plurality of data sources in order to receive the coded data corresponding to the one or more locations. Examples of a device from among the plurality of devices may include a mobile communication device, a mobile network appliance, a personal computer (PC), a laptop, a tablet PC, a personal digital assistant (PDA), a web appliance, a network appliance, a user accessory, such as a wrist watch, or any device capable of receiving the coded data from a data source from among the plurality of data sources. In an embodiment, the received coded data may be configured to facilitate navigation in the indoor environment 100. A system configured to facilitate navigation in an indoor environment, such as the indoor environment 100, is explained herein with reference to FIG. 2.

FIG. 2 is a block diagram of an exemplary system 200 configured to facilitate navigation in indoor environments, such as the indoor environment 100 of FIG. 1, in accordance with an embodiment. In an embodiment, the system 200 is configured to be included within a device, such as a device from among the plurality of devices of FIG. 1. In an exemplary embodiment, the system 200 may be configured within a machine capable of executing a set of instructions (sequential and/or otherwise) so as to enable navigation of the user in the indoor environment. In an exemplary embodiment, the system 200 may be configured within a Smartphone, a mobile communication device, a PC, a laptop, a tablet PC, a PDA or a user accessory such as a wrist watch.

In an embodiment, the system 200 includes a data acquisition module 202, a processing module 204, a display module 206 and a memory module 208. In an embodiment, the data acquisition module 202, the processing module 204, the display module 206 and the memory module 208 are configured to communicate with each other via or through a bus 210. Examples of the bus 210 may include, but are not limited to, a data bus, an address bus, a control bus, and the like. The bus 210 may be, for example, a serial bus, a bi-directional bus or a unidirectional bus.

In an embodiment, the data acquisition module 202 is configured to receive coded data corresponding to a plurality of destinations in the indoor environment from at least one data source, such as the plurality of data sources of FIG. 1, provided in the indoor environment. In an embodiment, the data acquisition module 202 may be embodied in the form of an image-capturing unit and may be configured to capture an image of a data source such as a QR tag, which may subsequently be interpreted for receiving the coded data. In an embodiment, the data acquisition module 202 may include QR code scanner applications, such as Red Laser, which may be configured to read the QR tag. In an embodiment, the device, including the system 200, may be directed towards the data source, such as a QR tag or a barcode, so as to enable the data acquisition module 202 to receive the coded data. In an embodiment, the data acquisition module 202 may be embodied in the form of a transceiver and configured to request the coded data from a data source, such as a NFC based apparatus, a Bluetooth® based device and a Wi-FI based device. In an embodiment, the request may be provided in the form of a wireless signal to the data source. In an embodiment, the coded data may be received by the data acquisition module 202 from the data source upon providing the request to the data source for provision of the coded data.

In an embodiment, the processing module 204 is configured to determine one or more navigation paths corresponding to at least one destination from among the plurality of destinations based on the received coded data. In an embodiment, the processing module 204 may be configured to interpret the coded data received by the data acquisition module 202 and determine the one or more navigation paths. In an embodiment, the processing module 204 may be embodied as a multi-core processor, a single core processor, or a combination of one or more multi-core processors and one or more single core processors. For example, the processing module 204 may be embodied as one or more of various processing devices, such as a coprocessor, a microprocessor, a controller, a digital signal processor (DSP), processing circuitry with or without an accompanying DSP, or various other processing devices including integrated circuits, such as, for example, an application specific integrated circuit (ASIC), a field programmable gate array (FPGA), a microcontroller unit (MCU), a hardware accelerator, a special-purpose computer chip, or the like. In an embodiment, the processing module 204 may be configured to execute hard-coded functionality. In an embodiment, the processing module 204 is embodied as an executor of software instructions, wherein the instructions may specifically configure the processing module 204 to perform the algorithms and/or operations described herein when the instructions are executed. The processing module 204 may include, among other things, a clock, an arithmetic logic unit (ALU) and logic gates configured to support an operation of the processing module 204.

In an embodiment, the processing module 204 is configured to determine an initial location of the user based on a location of a first data source from among the at least one data source upon receiving coded data from the first data source. In an embodiment, a user may seek coded data from the first data source from among the many data sources that the user comes across in the indoor environment. For example, a data source from among the plurality of data sources may be provided at an entrance of the indoor environment. The user may come across the data source provided at the entrance when entering the indoor environment and seek to receive the coded data from the data source. Such a data source may be considered to be the first data source. In an embodiment, location co-ordinates of the first data source may be associated with the user seeking the coded data in order to determine the initial location of the user. For example, if the location co-ordinates of the first data source are X degree latitude and Y degree longitude, then the initial location of the user may be determined to be X, Y as a result of the proximity of the user to the first data source during the receipt of the coded data from the first data source.

In an embodiment, the display module 206 is configured to display one or more destinations from among the plurality of destinations based on the initial location of the user and the coded data received from the first data source. As explained herein with reference to FIG. 1, the coded data received from a data source, such as the first data source, may correspond to a plurality of destinations and include at least one of milestone information, direction information and distance information with reference to a location, such as the initial location, of the user in the indoor environment. The processing module 204 may interpret the coded data and, in conjunction with the display module 206, may cause one or more destinations from among the plurality of destinations to be displayed (e.g., by the display module 206).

In an embodiment, the processing module 204 may be configured to determine destinations to be displayed based on the proximity of the destinations to the location of the user. For example, if the received coded data indicates a close proximity of the initial location of the user to a bookstore and flower shop, the processing module 204 may determine the bookstore and the flow shop as destinations to be displayed to the user. In an embodiment, the display module 206 may be configured to generate a user interface (UI) based view in order to display the one or more destinations to the user.

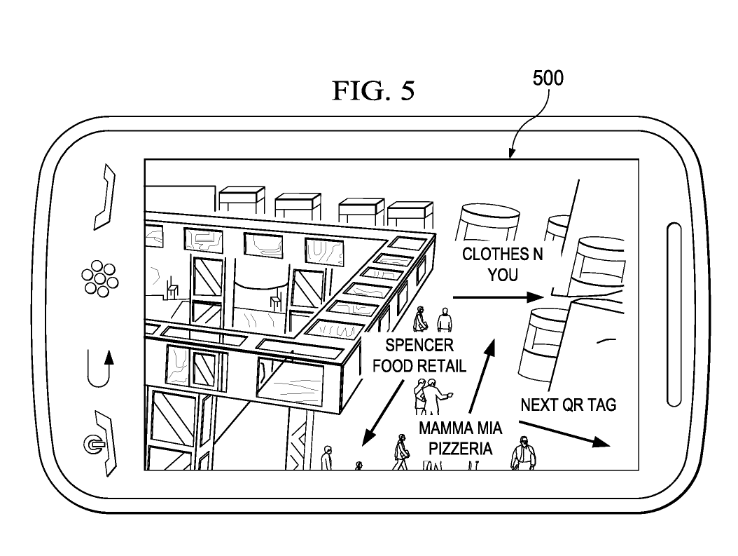

In an embodiment, the UI based view is generated based on augmented reality (AR). It is noted that the term “augmented reality” is construed as referring to a live, direct or indirect, view of a physical, real-world environment whose elements are augmented by machine-generated sensory inputs such as, for example, sound, video, graphics or GPS data. In an embodiment, the display module 206 may be configured to include an AR browser application. Upon activating the AR browser application, a viewfinder mode (for example, a mode utilized for capturing images) associated with the display module 206 may be activated. The surrounding environment view (for example, a view of an area surrounding the initial location of the user) may be augmented with milestone information (for example, milestone information, such as the names of destinations) to generate the AR based view. The AR based view and the one or more destinations are explained further herein with reference to FIG. 5.

In an embodiment, the UI based view is generated by overlaying milestone information corresponding to the one or more destinations over one of a view captured by an image view-finder associated with the device and a pre-loaded map associated with the device. In an embodiment, the pre-loaded map may correspond to a static and/or dynamic map stored in the device. In an embodiment, information included in the pre-loaded map may be out-dated and out-of-sync with the surrounding environment, and accordingly, milestone information corresponding to the one or more destinations may be overlaid on the pre-loaded map in order to generate the UI based view.

In an embodiment, the data acquisition module 202 is configured to receive a selection of the at least one destination from among the plurality of destinations from the user. For example, one or more destinations, such as a bookstore, a clothing outlet and a restaurant may be displayed to a user based on the initial location of the user in an indoor environment, such as a shopping mall. The user may provide the selection of at least one destination, such as, for example, a clothing outlet and a restaurant, from among the one or more destinations. In an embodiment, the data acquisition module 202 may be configured to receive the selection in the form of one of a touch input, a voice input, a keypad input and a trackball input.

In an embodiment, the processing module 204 is configured to determine one or more navigation paths corresponding to at least one destination from the initial location based on the received coded data. In an embodiment, the display module 206 may be configured to display the one or more navigation paths (for example, by overlaying the one or more navigation paths over the surrounding environment view) in order to guide the user to travel to the selected at least one destination. In an embodiment, the user may keep the UI based view (for example, via the AR browser application) active for the viewing of the one or more navigation paths to the at least one destination in an on-going manner.

In an embodiment, a current location of the user may be dynamically tracked in order to guide the user while traversing the one or more navigation paths. In an embodiment, the current location may be dynamically tracked by tracking the rate of motion and a direction of travel of the user from the initial location using at least one of an accelerometer, a gyroscope and one or more motion sensors configured for motion estimation and depth estimation. Examples of motion sensors may include, for example, inertial measurement unit (IMU) sensors, micro-electromechanical systems (MEMS) based sensors, and the like.

In an embodiment, the coded data received from a data source from among the at least one data source provided in the indoor environment comprises at least one of milestone information, direction information and distance information corresponding to another data source provided in the indoor environment. For example, the coded data received from the first data source may be configured to include information regarding a location of another data source that is located in close proximity to the first data source. In an embodiment, such information may be included so as to enable the user to avail himself/or herself of coded data corresponding to destinations for which information was not included in the first data source. In an embodiment, the information regarding the location of another data source may be included so as to enable the user to receive coded data in order to travel to a specific destination from his/her new location (for example, the location of the another data source).

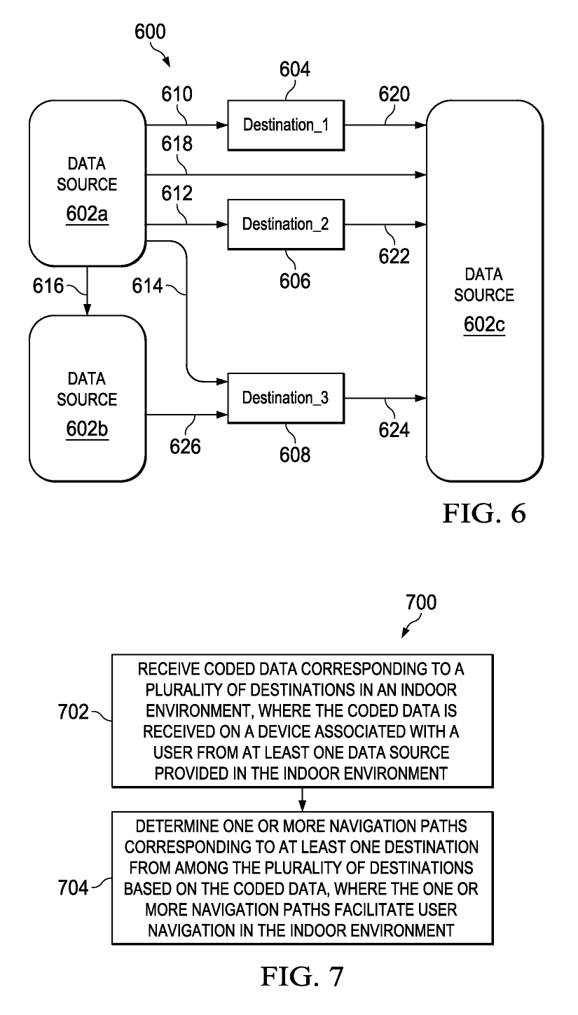

In an embodiment, the user may come across one or more data sources provided in the indoor environment when traversing the navigation paths. The user may further receive coded data from the one or more data sources, which may provide another array of directions of travel to another set of destinations. In an embodiment, the processing module 204 is further configured to create a linked list of navigation paths by augmenting the one or more navigation paths with navigation paths determined based on coded data received from one or more subsequent data sources provided in the indoor environment. As used herein, the term ‘one or more subsequent data sources’ may refer to one or more data sources that a user comes across upon receiving the coded data from the first data source. In an embodiment, the linked list of navigation paths may correspond to a relational database of navigation data linking the plurality of destinations in the indoor environment with navigation paths. The linked list is explained further herein with reference to FIG. 6.

In an embodiment, the linked list of navigation paths is configured to enable a determination of a current location of the user based on “dead reckoning”. The term “dead reckoning” as used herein may be construed as referring to, for example, a process of estimating a current location based on a previously traversed destination and a direction/speed of travel that is subsequently traversed. In some embodiments, the motion sensors and/or accelerometers/gyroscopes may be affected by drift as a result of a variety of external environmental factors, and, accordingly, may not accurately reflect the current location of the user. In such situations, the linked list of navigation paths may be utilized to perform dead reckoning in order to enable the user to re-orient his/her direction and reach the specific destination or navigate to a previously traversed destination.

In an embodiment, the processing module 204 is configured to dynamically generate a navigation map for the indoor environment based on the linked list of navigation paths. It is noted that the term “navigation map” may be construed as referring to a relative representation of one or more destinations within the indoor environment and one or more navigation paths leading to the one or more destinations within the indoor environment. In an embodiment, the dynamic generation of the navigation map may be initiated from the one or more navigation paths determined based on the coded data received from the first data source. The navigation map may be updated with navigation paths based on coded data received from one or more subsequent data sources. In an embodiment, the dynamically generated navigation map may enable the user to travel to various destinations within the indoor environment, trace his/her way back to the entrance/exit of the indoor environment, and the like. The navigation map may be, for example, a static map, an augmented map, and the like. In an embodiment, the display module 206 is configured to display the generated navigation map.

In an embodiment, the memory module 208 may be configured to store the linked list and/or navigation map generated for the indoor environment. In an embodiment, the user may utilize the generated navigation map upon subsequent visits to the indoor environment. In an embodiment, the navigation maps may be configured to be updated dynamically upon receiving coded data from one or more data sources provided in the indoor environment during the subsequent visits to the indoor environment. Examples of the memory module 208 may include, but are not limited to, random access memory (RAM), dual port RAM, synchronous dynamic RAM (SDRAM), double data rate SDRAM (DDR SDRAM), and the like.

In an embodiment, the system 200 additionally includes components, such as an input unit (e.g., an image processing device), a video display unit (e.g., liquid crystals display (LCD), a cathode ray tube (CRT), and the like), a cursor control device (e.g., a mouse), a drive unit (e.g., a disk drive), a signal generation unit (e.g., a speaker) and/or a network interface unit. The input unit is configured to transfer the coded data to the processing module 204 for the processing of the coded data. The drive unit includes a machine-readable medium upon which is stored one or more sets of instructions (e.g., software) embodying one or more of the methodologies and/or functions described herein. In an embodiment, the software resides, either completely or partially, within the memory module 208 and/or within the processing module 204 during the execution thereof by the system 200, such that the memory module 208 and processing module 204 also constitute a machine-readable media. The software may further be transmitted and/or received over a network through the network interface unit.

The term “machine-readable medium” may be construed to include a single medium and/or multiple media (e.g., a centralized and/or distributed database, and/or associated caches and servers) that store the one or more sets of instructions. Moreover, the term “machine-readable medium” may be construed to include any medium that is capable of storing, encoding and/or carrying a set of instructions for execution by the system 200 and that cause the system 200 to perform any one or more of the methodologies of the various embodiments. Furthermore, the term “machine-readable medium” may be construed to include, but shall not be limited to, solid-state memories, optical and magnetic media, and carrier wave signals.

FIG. 3 illustrates an exemplary data source in the form of a quick response (QR) tag 300 in accordance with an embodiment. As depicted in FIG. 3, the QR tag 300 is a type of two-dimensional matrix barcode including black square dots arranged in a square pattern on a white background. In an embodiment, the QR tag 300 may include coded data in the form of at least one of numeric data, alphanumeric data, byte/binary data and/or Kanji data. Further, the QR tag 300 may store the coded data in horizontal and vertical directions and can be scanned vertically or horizontally in order to decode the coded data. The QR tag 300 may be provided in an indoor environment, such as the indoor environment 100. An exemplary provision of QR tag 300 in the indoor environment is depicted in FIG. 4.

FIG. 4 depicts an exemplary provision of the QR tag 300 of FIG. 3 in an indoor environment 400 in accordance with an embodiment. As explained herein with reference with FIG. 2, one or more data sources, such as the QR tag 300, may be provided at various locations, such as, for example, near an entrance of the indoor environment, near elevators or vending machines, on each storey of a multi-storied building, outside offices of the indoor environment, and the like. In FIG. 4, the indoor environment 400 is depicted to be an area within a shopping mall. The QR tag 300 is depicted to be displayed at an entrance of the indoor environment 400.

The indoor environment 400 is depicted to include a plurality of users (and/or customers). The users may receive coded data corresponding to a plurality of destinations in the indoor environment 400 from the QR tag 300. One user, such as, for example, user 402, is depicted to capture an image of the QR tag 300 on a device 404 associated with the user. The device 404 may include a system, such as system 200, configured to facilitate navigation in the indoor environment. The captured image of the QR tag 300 on the device 404 associated with the user 402 is depicted in an inset view 406. As explained in FIG. 2, the data acquisition module 202 of the system 200 may be embodied in the form of an image capture unit which may capture an image of a QR tag, such as the QR tag 300, which may subsequently be interpreted such that the coded data is consequently received. In an embodiment, the data acquisition module 202 may include QR code scanner applications, such as Red Laser, which may be configured to read the QR tag 300 such that the coded data is consequently received.

It is noted that although the data source in FIGS. 3 and 4 is depicted to be a QR tag, a variety of data sources, such as bar codes, NFC based apparatuses, Bluetooth® devices, Wi-Fi based devices, and the like, may be provided at various locations in the indoor environment 400. Further, the coded data may be in forms other than the QR code, such as, for example, NFC, Bluetooth® signals, or Wi-Fi signals.

As explained herein with reference to FIG. 2, the coded data may include information corresponding to a plurality of destinations in an indoor environment, such as the indoor environment 400. Further, the information corresponding to each destination may include at least one of milestone information, direction information and distance information with reference to a location of the user in the indoor environment. In an embodiment, the information corresponding to a plurality of destinations may be stored in the form of a look-up table in coded form. An exemplary look-up table, including information corresponding to the plurality of destinations in an indoor environment, such as a shopping mall, is depicted in Table 1.

TABLE 1

| Distance Information | Direction Information | Milestone Information |
|---|---|---|
| 15 meters | 30 degrees North | Mamma Mia Pizzeria |
| 30 meters | 40 degrees South | Spencer Food Retail |
| 10 meters | 60 degrees West | Exit # 1 |
| 15 meters | 45 degrees East | Clothes n U |
| 5 meters | 45 degrees East | Next QR Tag |

As can be seen from Table 1, the coded data includes distance, direction and milestone information corresponding to a plurality of destinations, such as a pizza joint (for example, Mamma Mia Pizzeria), a food retailer (for example, Spencer Food Retail), a clothing outlet (for example, Clothes n You), the next QR tag location and even a location for exiting the shopping mall. For example, the pizza joint ‘Mamma Mia Pizzeria’ is at a distance of 15 meters in the 30 degrees North direction from the location of the user. Similarly, the food retailer ‘Spencer Food Retail’ is at a distance of 30 meters in the 40 degrees South direction. A location of an exit, such as exit #1, is at a distance of 10 meters from the user location in the 60 degrees West direction. A clothing outlet ‘Clothes n You’ is at a distance of 15 meters in the 45 degrees East direction. Further, a location of a next QR tag, such as the QR tag 300, is at distance of 5 meters in the 45 degrees East direction.

Based on the location of the user (for example, the initial location and/or current location) and on the received coded data, one or more destinations may be displayed to the user. Accordingly, the processing module 204 may select destinations, such as Mamma Mia Pizzeria, Spencer Food Retail, Exit #1, Clothes n You and the location of the next QR tag to be displayed to the user as a result of the proximity of these locations to the user. An exemplary display of a plurality of destinations is depicted in FIG. 5.

FIG. 5 depicts an exemplary UI based view 500 generated in order to display a plurality of destinations to a user in accordance with an embodiment. As explained herein with reference to FIG. 4, the coded data corresponding to the QR tag 300 may be received and subsequently decoded in order to obtain information as exemplarily depicted in Table 1. The processing module 204 may select destinations, such as Mamma Mia Pizzeria, Spencer Food Retail, Exit #1, Clothes n You and the location of the next QR tag to be displayed to the user as a result of the proximity of these locations to the user.

As explained herein with reference to FIG. 2, the display module 206 may be configured to include an AR browser application. Upon activating the AR browser application, a viewfinder mode (for example, a mode utilized for capturing images) associated with the display module 206 may be activated. The surrounding environment view (for example, a view of an area surrounding the initial location of the user) may be augmented with milestone information (for example, milestone information, such as names of destinations) in order to generate the UI based view, such as the UI based view 500. Accordingly, milestone information corresponding to some of the destinations, such as Mamma Mia Pizzeria, Spencer Food Retail, the next QR tag and Clothes n You, are depicted to be overlaid upon the surrounding view captured by the viewfinder associated with the display module 206.

Further, the user may provide a selection of at least one destination from among the plurality of destinations. For example, the user may select ‘Clothes n You’ as the specific destination from among the plurality of destinations. In an embodiment, the data acquisition module 202 may be configured to receive the selection in the form of one of a touch input, a voice input, a keypad input and a trackball input. From the Table 1, it is deduced that the clothing outlet, ‘Clothes n You’, is at a distance of 15 meters at an angle of 45 degrees in the Eastern direction. In an embodiment, the processing module 204 is configured to determine one or more navigation paths corresponding to the selected destination from the location of the user based on the received coded data. In an embodiment, the display module 206 may be configured to display the determined one or more navigation paths (for example, by overlaying the one or more navigation paths over the surrounding environment view) in order to guide the user to travel to the selected destination. In an embodiment, the user may keep the AR browser application active with the corresponding UI based view 500 displaying the one or more navigation paths to the at least one destination. The user may proceed towards the clothing outlet based on the direction displayed in the viewfinder mode. In an embodiment, the user may retain the display in the viewfinder mode in order to be guided during navigation while traversing a navigation path to the destination. Further, as explained in FIG. 2, one or more motion sensors, gyroscopes, accelerometers and such utilities may dynamically track a direction of motion and a rate of motion of the user while traversing the determined one or more navigation paths. The tracking information may be utilized to update the UI based view 500 in order to aid the user to navigate to the selected destination.

In an embodiment, the user may navigate to the next QR tag in order to receive coded data from the next QR tag. The user may receive coded data, such as information depicted in Table 1, from the next QR tag. In an embodiment, the user may navigate to the next QR tag in order to avail himself/or herself of coded data corresponding to destinations for which information was not included in the QR tag 300. In an embodiment, the information regarding the location of the next QR tag may be included in the QR tag 300 so as to enable the user to receive coded data that will then enable the user to travel to a specific destination from his/her new location (for example, the location of the next QR tag).

In FIG. 5, the UI based view 500 is depicted as being generated based on an augmented reality. However, it is noted that the UI based view 500 may be generated by overlaying the milestone information corresponding to the one or more destinations on a pre-loaded map as explained herein with reference to FIG. 2. As explained herein with reference to FIG. 2, the coded data received from data sources, such as the various QR tags, may be combined so as to create a linked list, such as, for example, a relational database of navigation paths, which may then be utilized to generate a navigation map of the indoor environment. The linked list creation is explained herein with reference to FIG. 6.

FIG. 6 depicts an exemplary schematic of a linked list 600 created for generation of a navigation map in accordance with an embodiment. As explained in FIG. 2, one or more data sources, such as a data source 602a, a data source 602b and a data source 602c (for example, data sources such as QR tag 300), are provided in an indoor environment, such as the indoor environments 100, 400. Each data source includes coded data comprising at least one of milestone information, distance information, and direction information corresponding to a plurality of destinations. For example, data source 602a includes coded data corresponding to destination_{—}1 604, destination_{—}2 606 and destination_{—}3 608 in the indoor environment. Further, the data source 602a includes coded data corresponding to the locations of data source 602b and data source 602c.

As may be observed from FIG. 6, the coded data included in the data source 602a may facilitate navigation of a user from the location of the data source 602a (1) to destination_{—}1 604 along navigation path 610, (2) to destination_{—}2 606 along navigation path 612, and (3) to destination_{—}3 608 along navigation path 614. Further, a user may also traverse navigation paths 616 and 618 in order to reach locations of data source 602b and 602c, respectively. Pursuant to one embodiment, however, the user may visit any of the destinations 604, 606 and 608 and proceed to the location of data source 602c along navigation paths 620, 622 and 624, respectively. The user may also travel to the location of data source 602b by utilizing navigation path 616 and receive coded data from the data source 602b in order to learn about the navigation path 626 so as to reach the destination_{—}3 608.

As explained herein with reference to FIG. 2, the user may receive coded data from multiple data sources provided in the indoor environment. The corresponding navigation paths deduced from the coded data received from each of the data sources may be utilized in order to create the linked list 600 of navigation paths. In an embodiment, the created linked list 600 may be in the form of a relational database including information, such as multiple possible navigation paths, that may be utilized to reach a specific destination, interconnection among navigation paths, and the like. For example, in FIG. 6, the user may travel from the location of data source 602a to the destination_{—}1 604 using the navigation path 610, and then proceed to the location of the data source 602c along the navigation path 620. The user may receive coded data from the data source 602c and may travel to destination_{—}2 606 along navigation path 622. The linked list 600 created based on the coded data received from the data sources 602a and 602c may be augmented with coded data received from the data source 602b, thereby building a database of navigation paths.

In an embodiment, the created linked list, such as the created linked list 600, may be utilized to dynamically generate a navigation map for navigation in the indoor environment. The navigation map may be dynamically updated with the corresponding updates in the linked list 600 in response to the receipt of coded data from newer data sources. More specifically, the dynamic generation of the navigation map may be initiated from the one or more navigation paths determined based on the coded data received from the first data source. The navigation map may thereafter be dynamically updated with determined navigation paths based on coded data received from one or more subsequent data sources. In an embodiment, the navigation map may be utilized to facilitate navigation from one destination to another in the indoor environment. Further, the navigation map may also enable a user to perform dead reckoning and/or retrace his/her location to the initial location. Further, as explained in FIG. 2, the memory module 208 may store the navigation map and facilitate navigation of the user in the indoor environment during subsequent visits to the indoor environment. A first method of facilitating navigation in the indoor environment is explained herein with reference to FIG. 7.

FIG. 7 is a flow diagram of a first method 700 of facilitating navigation in an indoor environment in accordance with an embodiment. As explained herein with reference to FIG. 1, the term ‘indoor environment’ may refer to covered spaces and/or areas within building structures, such as, for example, office spaces, malls, parking lots, hospitals, and the like. The method 700 depicted in the flow diagram may be executed by, for example, the system 200 of FIG. 2. Operations of the flowchart, and combinations of operations in the flowchart, may be implemented by various devices, such as hardware, firmware, a processor, circuitry and/or other devices associated with the execution of software including one or more computer program instructions. The operations of the method 700 are described herein with the help of the system 200. However, the operations of the method 700 can be described and/or practiced by using any other system. The method 700 starts at operation 702.

At operation 702, coded data corresponding to a plurality of destinations in an indoor environment is received (for example, by using the data acquisition module 202 of FIG. 2) on a device associated with a user (for example, a device from among the plurality of devices of FIG. 1) from at least one data source provided in the indoor environment. In an embodiment, a data source of at least one data source may be one of a QR tag such as the QR tag 300 of FIG. 1, a NFC based apparatus, a Bluetooth® based device and a Wi-Fi based device. Further, the coded data may be in the form of a QR code, a bar code, a NFC signal, a Bluetooth® signal (for example, a Bluetooth® low energy signal), a Wi-Fi signal, and the like.

As explained herein with reference to FIG. 4, an image of a data source, such as a QR tag, may be captured using a device associated with the user. The captured image may subsequently be interpreted such that the coded data may be received based on this interpretation. In an embodiment, the coded data may be received upon, or subsequent to, directing the device associated with the user towards the data source. In an embodiment, code-scanning functions (e.g., embodied in any of hardware, software and/or firmware), such as a QR code scanner or a barcode scanner, may be employed (for example, by using the data acquisition module 202 of system 200 in the user device) to receive the coded data. In an embodiment, coded data may be requested (for example, by using the data acquisition module 202 of system 200 in the user device) from a data source, such as a NFC based apparatus, a Bluetooth® based device or a Wi-Fi based device. In an embodiment, the request may be provided in the form of a wireless signal to the data source. In an embodiment, the coded data may be received from the data source upon providing the request to the data source that the coded data be provided.

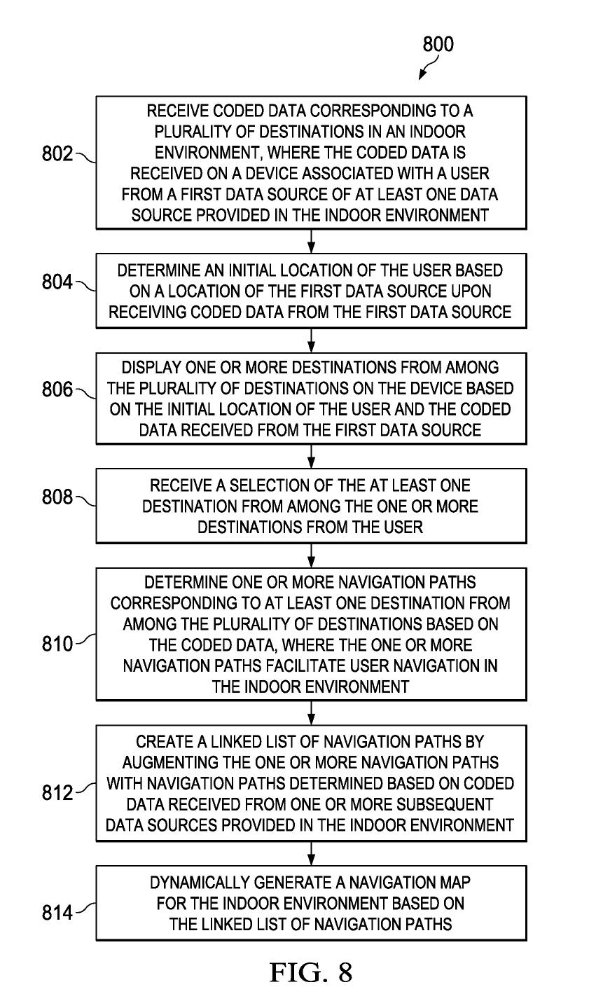

At operation 704, one or more navigation paths corresponding to at least one destination from among the plurality of destinations may be determined (for example, by using the processing module 204 of FIG. 2) based on the coded data. The one or more navigation paths facilitate user navigation in the indoor environment. In an embodiment, the coded data corresponds to a plurality of destinations in the indoor environment. Further, coded data corresponding to a destination from among the plurality of destinations comprises at least one of milestone information, direction information and distance information with reference to a location of the user in the indoor environment, as depicted in Table 1 and with reference to FIG. 4. In an embodiment, the received coded data may be decoded (for example, by using the processing module 204 of FIG. 2) in order to retrieve the distance/direction/milestone information corresponding to the plurality of destinations. The one or more navigation paths to the at least one destination from among the plurality of destinations may be determined based on the retrieved distance/direction/milestone information corresponding to the plurality of destinations, as explained herein with reference to FIGS. 4 and 5. A second method of facilitating navigation in an indoor environment is explained herein with reference to FIG. 8.

FIG. 8 is a flow diagram of a second method 800 of facilitating navigation in an indoor environment in accordance with an embodiment. The method 800 depicted in the flow diagram may be executed by, for example, the system 200 of FIG. 2. Operations of the flowchart, and combinations of operations in the flowchart, may be implemented by various means, such as hardware, firmware, a processor, circuitry and/or other devices associated with the execution of software including one or more computer program instructions. The operations of the method 800 are described with reference to the system 200. However, the operations of the method can be described and/or practiced by using any other system. The method 800 starts at operation 802.

At operation 802, coded data corresponding to a plurality of destinations in an indoor environment is received (for example, by using the data acquisition module 202 of FIG. 2) on a device associated with a user (for example, a device from among the plurality of devices of FIG. 1) from a first data source of at least one data source provided in the indoor environment. The receipt of the coded data is performed as explained in operation 702 with reference to FIG. 7 and is not explained herein. In an embodiment, a user may seek coded data from the first of the many data sources that the user comes across in the indoor environment. For example, a data source from among the plurality of data sources may be provided at an entrance of the indoor environment. The user may come across the data source provided at the entrance when entering the indoor environment and seek to receive the coded data from the data source. Such a data source may be considered to be the first data source.

At operation 804, an initial location of the user is determined (for example, by using the processing module 204 of FIG. 2) based on a location of the first data source upon receiving coded data from the first data source. In an embodiment, location co-ordinates of the first data source may be associated with the user seeking the coded data in order to determine the initial location of the user. For example, if the location co-ordinates of the first data source are X degree latitude and Y degree longitude, then the initial location of the user may be determined to be X, Y as a result of the proximity of the user to the first data source during the receipt of the coded data from the first data source.

At operation 806, one or more destinations from among the plurality of destinations are displayed (for example, by using the display module 206 of FIG. 2) based on the initial location of the user and the coded data received from the first data source. As explained herein, the coded data received from the first data source may include information as depicted in Table 1 and with reference to FIG. 4. More specifically, the coded data may include information such as milestone information, direction information, and distance information corresponding to the plurality of destinations. The coded data may be interpreted for display of the one or more destinations from among the plurality of destinations in the indoor environment. In an embodiment, destinations to be displayed may be determined based on the proximity of the destinations to the location of the user. For example, if the received coded data indicates a close proximity of the initial location of the user to a vending machine, the vending machine may be determined as a destination to be displayed to the user.

In an embodiment, a UI based view, such as UI based view 500, may be generated (for example, by using the display module 206 of FIG. 2) in order to display the one or more destinations to the user. In an embodiment, the UI based view is generated based on AR as explained herein with reference to FIG. 5. In an embodiment, the UI based view is generated by overlaying milestone information corresponding to the one or more destinations over one of a view captured by an image view-finder associated with a user device and a pre-loaded map associated with the user device. In an embodiment, the pre-loaded map may correspond to a static and/or dynamic map stored in the user device. In an embodiment, information included in the pre-loaded map may be out-dated and out-of-sync with the surrounding environment and, accordingly, milestone information corresponding to the one or more destinations may be overlaid on the pre-loaded map in order to generate the UI based view. The display of the one or more destinations may be performed as explained herein with reference to FIG. 5.

At operation 808, a selection of the at least one destination from among the one or more destinations may be received (for example, by using the data acquisition module 202 of FIG. 2) from the user. In an embodiment, the selection may be received in the form of one of a touch input, a voice input, a keypad input and a trackball input. For example, one or more destinations, such as a bookstore, a clothing outlet and a restaurant may be displayed to a user based on the initial location of the user in an indoor environment, such as a shopping mall. The user may provide the selection of at least one destination, such as, for example, a clothing outlet and a restaurant, from among the plurality of target destinations.

At operation 810, one or more navigation paths corresponding to at least one destination from among the plurality of destinations may be determined (for example, by using the processing module 204 of FIG. 2) based on the received coded data. The one or more navigation paths facilitate user navigation in the indoor environment. The determination of the one or more navigation paths may be performed as explained in operation 704 (with reference to FIG. 7).

In an embodiment, a current location of the user may be dynamically tracked in order to guide the user while the user is traversing the one or more navigation paths. In an embodiment, the current location may be dynamically tracked by tracking the rate of motion and a direction of travel of the user from the initial location using at least one of an accelerometer, a gyroscope and one or more motion sensors configured for motion estimation and depth estimation. Examples of motion sensors may include IMU sensors, MEMS based sensors, and the like.

In an embodiment, the coded data received from a data source from among the at least one data source provided in the indoor environment comprises at least one of milestone information, direction information and distance information corresponding to another data source provided in the indoor environment. For example, the coded data received from the first data source may be configured to include information regarding a location of another data source located in close proximity to the first data source. In an embodiment, such information may be included to enable the user to avail himself/herself of coded data corresponding to destinations for which information was not included in the first data source. In an embodiment, the information regarding the location of another data source may be included in order to enable the user to receive coded data so as to travel to a specific destination from his/her new location (for example, the location of the another data source).

In an embodiment, the user may encounter one or more data sources provided in the indoor environment when traversing the navigation paths. The user may further receive coded data from the one or more data sources, which may provide another set of destinations with corresponding navigation paths. At operation 812, a linked list of navigation paths is created (for example, by using the processing module 204 of FIG. 2) by augmenting the determined one or more navigation paths with navigation paths determined based on coded data received from one or more subsequent data sources provided in the indoor environment. As explained herein with reference to FIG. 6, the linked list of navigation paths may correspond to a relational database of navigation data linking the plurality of destinations in the indoor environment with navigation paths. In an embodiment, the linked list of navigation paths is configured to enable a determination of a current location of the user based on a dead reckoning, such as explained herein with reference to FIG. 2. At operation 814, a navigation map may be dynamically generated for the indoor environment based on the linked list of navigation paths. In an embodiment, the dynamic generation of the navigation map may be initiated from the one or more navigation paths determined based on the coded data received from the first data source. The navigation map may be updated with determined navigation paths based on coded data received from one or more subsequent data sources. In an embodiment, the dynamically generated navigation map may enable the user to travel to various destinations within the indoor environment, trace his/her way back to the entrance/exit of the indoor environment, and the like. The navigation map may be, for example, a static map, an augmented map, and the like.

Without in any way limiting the scope, interpretation, or application of the claims appearing below, advantages of one or more of the exemplary embodiments disclosed herein include facilitating navigation in indoor environments. The suggested techniques for user navigation are especially useful in indoor environments, where pre-loaded maps are obsolete or no Wi-Fi, cellular or GNSS signals are available for determining a user position and the subsequent tracking of the user location. Further, various embodiments of the present technology suggest techniques for the dynamic building of navigation maps for various indoor environments, such as malls, parking areas, and building complexes, for which maps are not available, thereby causing navigation in such environments to be difficult. The present technology suggests techniques for enhanced user experience by providing support for augmented reality based navigation in indoor environment. Further, support for AR based navigation allows the opportunity for the provision of various location based services, such as targeted advertisements and/or customized marketing to users based on location. Furthermore, the suggested techniques for facilitating navigation in indoor environments may be implemented in various user devices, such as smart phones and the like.

Although the present technology has been described with reference to specific exemplary embodiments, it is noted that various modifications and changes may be made to these embodiments without departing from the broad spirit and scope of the present technology. For example, the various devices, modules, analyzers, generators, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the various electrical structures and methods may be embodied using transistors, logic gates, and electrical circuits (for example, ASIC circuitry and/or in DSP circuitry).

Particularly, the system 200, the data acquisition module 202, the processing module 204, the display module 206 and the memory module 208 may be enabled using software and/or using transistors, logic gates, and electrical circuits (for example, integrated circuit circuitry such as ASIC circuitry). Various embodiments of the present disclosure may include one or more computer programs stored or otherwise embodied on a computer-readable medium, wherein the computer programs are configured to cause a processor or computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In come embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), DVD (Digital Versatile Disc), BD (Blu-ray (registered trademark) Disc), and semiconductor memories (such as mask ROM, PROM (programmable ROM), EPROM (erasable PROM), flash ROM, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Also, techniques, devices, subsystems and methods described and illustrated in the various embodiments as discrete or separate may be combined or integrated with other systems, modules, techniques, or methods without departing from the scope of the present technology. Other items shown or discussed as directly coupled or communicating with each other may be coupled through some interface or device, such that the items may no longer be considered directly coupled with each other but may still be indirectly coupled and in communication, whether electrically, mechanically, or otherwise, with one another. Other examples of changes, substitutions, and alterations ascertainable by one skilled in the art, upon or subsequent to studying the exemplary embodiments disclosed herein, may be made without departing from the spirit and scope of the present technology.

It should be noted that reference throughout this specification to features, advantages, or similar language does not imply that all of the features and advantages should be or are in any single embodiment. Rather, language referring to the features and advantages may be understood to mean that a specific feature, advantage, or characteristic described in connection with an embodiment may be included in at least one embodiment of the present technology. Thus, discussions of the features and advantages, and similar language, throughout this specification may, but do not necessarily, refer to the same embodiment.

Various embodiments of the present disclosure, as discussed above, may be practiced with steps and/or operations in a different order, and/or with hardware elements in configurations which are different than those which are disclosed. Therefore, although the technology has been described based upon these exemplary embodiments, it is noted that certain modifications, variations, and alternative constructions may be apparent and well within the spirit and scope of the technology. Although various exemplary embodiments of the present technology are described herein in a language specific to structural features and/or methodological acts, the subject matter defined in the appended claims is not necessarily limited to the specific features or acts described above. Rather, the specific features and acts described above are disclosed as exemplary forms of implementing the claims.

1. A method comprising:
receiving coded data corresponding to a plurality of destinations in an indoor environment, wherein the coded data is received on a device associated with a user from at least one data source provided in the indoor environment; and
determining one or more navigation paths corresponding to at least one destination from among the plurality of destinations based on the coded data, wherein the one or more navigation paths facilitate user navigation in the indoor environment.

2. The method of claim 1, further comprising:
determining an initial location of the user based on a location of a first data source from among the at least one data source upon receiving coded data from the first data source;
displaying one or more destinations from among the plurality of destinations on the device based on the initial location of the user and the coded data received from the first data source; and
receiving a selection of the at least one destination from among the one or more destinations from the user prior to determining the one or more navigation paths.

3. The method of claim 2, further comprising dynamically tracking a current location of the user so as to guide the user while traversing the one or more navigation paths, wherein the current location of the user is dynamically tracked based on the initial location.

4. The method of claim 2, further comprising generating a user interface (UI) based view so as to display the one or more destinations to the user.

5. The method of claim 4, wherein the UI based view is generated based on augmented reality (AR).

6. The method of claim 4, wherein the UI based view is generated by overlaying a milestone information corresponding to the one or more destinations over one of a view captured by an image view-finder associated with the device and a pre-loaded map associated with the device.

7. The method of claim 2, further comprising creating a linked list of navigation paths by augmenting the one or more navigation paths with navigation paths determined based on coded data received from one or more subsequent data sources provided in the indoor environment.

8. The method of claim 7, further comprising dynamically generating a navigation map for the indoor environment based on the linked list of navigation paths.

9. The method of claim 7, wherein the linked list of navigation paths is configured to enable determination of a current location of the user based on dead reckoning.

10. The method of claim 1, wherein the coded data corresponding to a destination of the plurality of destinations comprises at least one of a milestone information, a direction information and a distance information with reference to a location of the user in the indoor environment.

11. The method of claim 1, wherein a data source from among the at least one data source is one of a quick response (QR) tag, a near field communication (NFC) based apparatus, a Bluetooth® based device and a Wi-Fi based device.

12. The method of claim 1, wherein coded data received from a data source from among the at least one data source provided in the indoor environment comprises at least one of a milestone information, a direction information, and a distance information corresponding to another data source provided in the indoor environment.

13. A system comprising:
a data acquisition module configured to receive coded data corresponding to a plurality of destinations in an indoor environment, wherein the coded data is received from at least one data source provided in the indoor environment;
a processing module communicatively associated with the data acquisition module and configured to determine one or more navigation paths corresponding to at least one destination from among the plurality of destinations based on the coded data; and
a display module communicatively associated with the data acquisition module and the processing module and configured to display the determined one or more navigation paths, wherein the one or more navigation paths facilitate user navigation in the indoor environment.

14. The system of claim 13, wherein:
the processing module is configured to determine an initial location of the user based on a location of a first data source from among the at least one data source upon receiving coded data from the first data source;
the display module is configured to display one or more destinations from among the plurality of destinations based on the initial location of the user and the coded data received from the first data source; and
the data acquisition module is configured to receive a selection of the at least one destination from among the one or more destinations from the user prior to determining the one or more navigation paths.

15. The system of claim 14, wherein the processing module is configured to dynamically track a current location of the user so as to guide the user while traversing the one or more navigation paths, wherein the current location of the user is dynamically tracked based on the initial location.

16. The system of claim 14, wherein the display module is further configured to generate a UI based view so as to display the one or more destinations to the user.

17. The system of claim 14, wherein the processing module is configured to:
create a linked list of navigation paths by augmenting the one or more navigation paths with navigation paths determined based on coded data received from one or more subsequent data sources provided in the indoor environment; and
dynamically generate a navigation map for the indoor environment based on the linked list of navigation paths.

18. A non-transitory computer-readable medium storing a set of instructions that when executed cause a computer to perform a method of facilitating navigation, the method comprising:
receiving coded data corresponding to a plurality of destinations in an indoor environment, wherein the coded data is received on a device associated with a user from at least one data source provided in the indoor environment; and
determining one or more navigation paths corresponding to at least one destination from among the plurality of destinations based on the coded data, wherein the one or more navigation paths facilitate user navigation in the indoor environment.

19. The non-transitory computer readable medium of claim 18, wherein the method further comprises:
determining an initial location of the user based on a location of a first data source from among the at least one data source upon receiving coded data from the first data source;
displaying one or more destinations from among the plurality of destinations on the device based on the initial location of the user and the coded data received from the first data source; and
receiving a selection of the at least one destination from the one or more destinations from the user prior to determining the one or more navigation paths.

20. The non-transitory computer readable medium of claim 19, where the method further comprises:
creating a linked list of navigation paths by augmenting the one or more navigation paths with navigation paths determined based on coded data received from one or more subsequent data sources provided in the indoor environment; and
dynamically generating a navigation map for the indoor environment based on the linked list of navigation paths.
